(19) United States
(12) Patent Application Publication
(10) Pub. No.: US 2025/0371322 A1
(43) Pub. Date: Dec. 4, 2025

(54) SYSTEM AND/OR METHOD FOR DETERMINING EXECUTION TASKS FOR COMPUTING A RESPONSE FOR SERVICING AN ELECTRONIC PROMPT

(71) Applicant: Incorta, Foster City, CA (US)

(72) Inventors: Mostafa Ali Mohamed Ali Abdelkader, Alexandria (EG); Osama AbdelKarim AboulHassan Mohamed, Alexandria (EG); Hania Mohamed Hani Anwar Mohamed, Alexandria (EG); Basem Mohammed Gaber Ahmed Hussein, Alexandria (EG)

(21) Appl. No.: 18/677,684

(22) Filed: May 29, 2024

(51) Int. Cl. G06N 3/0475

(52) U.S. Cl. CPC G06N 3/0475

(57) ABSTRACT

Disclosed are a system, method and apparatus to define computing tasks for servicing an electronic prompt. Responsive to a first prompt, a second prompt may be submitted to one or more generative neural network models. The second prompts may be based, at least in part, on the first prompt, and may specify a plurality of computing tools for use in constructing a requested response. The second prompt may request an identification of tasks to be executed based, at least in part, on at least some of the plurality of computing tools and based, at least in part, on execution dependencies between and/or among the identified tasks.

### BACKGROUND

### 1. Field

This disclosure relates to methods and/or techniques for structuring computing resources for solving computing problems.

### 2. Information

Solving computation problems in business, research and/or government typically involves the execution of multiple different tasks using corresponding executable computing modules. For example, solving such a computing problem may involve execution of multiple computing modules integrated to produce a desired computing result. Such a computing problem may be decomposed for selecting such computing modules using a large language model (LLM) agent.

In one aspect, an LLM-based agent may involve LLM applications that can execute complex tasks through the use of an architecture that combines LLMs with key modules like planning and memory. In building an LLM agent, an appropriate LLM may serve as a main controller or “brain” that controls a flow of operations that enables execution of a computing task and/or completion of servicing a user request.

### BRIEF DESCRIPTION OF DRAWINGS

Claimed subject matter is particularly pointed out and distinctly claimed in the concluding portion of the specification. However, both as to organization and/or method of operation, together with objects, features, and/or advantages thereof, it may best be understood by reference to the following detailed description if read with the accompanying drawings in which:

FIGS. 1A, 1B and 2 are schematic diagrams of system to service prompts using a trained large language model (LLM), according to an embodiment;

FIG. 3A is a flow diagram of a process for processing a prompt, according to an embodiment;

FIGS. 3B and 3C are expressions of portions of prompts, according an embodiment;

FIG. 3D is an expression of a plan for implementing a response to a user inquiry, according to one embodiment;

FIG. 3E is an expression of a plan for implementing a response to a user inquiry, according to another embodiment;

FIG. 4 is a flow diagram of a process for servicing a computing request, according to an embodiment;

FIG. 5 is a schematic diagram of a generative neural network model, according to an embodiment;

FIG. 6 is a schematic block diagram of an example computing system in accordance with an implementation;

FIG. 7 is a schematic diagram of a neural network formed in “layers”, according to an embodiment; and

FIG. 8 is a flow diagram of an aspect of a training operation, according to an embodiment.

Reference is made in the following detailed description to accompanying drawings, which form a part hereof, wherein like numerals may designate like parts throughout that are corresponding and/or analogous. It will be appreciated that the figures have not necessarily been drawn to scale, such as for simplicity and/or clarity of illustration. For example, dimensions of some aspects may be exaggerated relative to others. Furthermore, structural and/or other changes may be made without departing from claimed subject matter. It should also be noted that directions and/or references, for example, such as up, down, top, bottom, and so on, may be used to facilitate discussion of drawings and are not intended to restrict application of claimed subject matter. Therefore, the following detailed description is not to be taken to limit claimed subject matter and/or equivalents. Further, it is to be understood that other embodiments may be utilized. Also, embodiments have been provided of claimed subject matter and it is noted that, as such, those illustrative embodiments are inventive and/or unconventional; however, claimed subject matter is not limited to embodiments provided primarily for illustrative purposes. Thus, while advantages have been described in connection with illustrative embodiments, claimed subject matter is inventive and/or unconventional for additional reasons not expressly mentioned in connection with those embodiments. In addition, references throughout this specification to “claimed subject matter” refer to subject matter intended to be covered by one or more claims, and are not necessarily intended to refer to a complete claim set, to a particular combination of claim sets (e.g., method claims, apparatus claims, etc.), or to a particular claim.

### DETAILED DESCRIPTION

References throughout this specification to one implementation, an implementation, one embodiment, an embodiment, and/or the like means that a particular feature, structure, characteristic, and/or the like described in relation to a particular implementation and/or embodiment is included in at least one implementation and/or embodiment of claimed subject matter. Thus, appearances of such phrases, for example, in various places throughout this specification are not necessarily intended to refer to the same implementation and/or embodiment or to any one particular implementation and/or embodiment. Furthermore, it is to be understood that particular features, structures, characteristics, and/or the like described are capable of being combined in various ways in one or more implementations and/or embodiments and, therefore, are within intended claim scope. In general, of course, as has always been the case for the specification of a patent application, these and other issues have a potential to vary in a particular context of usage. In other words, throughout the patent application, particular context of description and/or usage provides helpful guidance regarding reasonable inferences to be drawn; however, likewise, “in this context” in general without further qualification refers to the context of the present patent application.

Large language models (LLMs) have been shown to deliver impressive performance in various natural language processing (NLP) tasks. To complete multi-step reasoning tasks, few-shot chain-of-thought (CoT) prompting may involve manually crafted step-by-step reasoning demonstrations, which may enable an LLM to explicitly generate reasoning steps and improve reasoning task accuracy. To eliminate a manual effort, a Zero-shot-CoT may concatenate a target problem statement with “Let's think step by step” as an input prompt to LLMs. Despite the success of Zero-shot-CoT, it still suffers from three pitfalls: calculation errors; missing-step errors; and semantic misunderstanding errors.

According to an embodiment, missing-step errors, a Plan-and-Solve (PS) prompting technique may be employed. Such a PS prompting technique may consist of two components: 1) devising a plan to partition and/or segment an entire computing task into smaller subtasks followed by 2) executing the subtasks according to the plan. To address computation errors and improve the quality of generated reasoning steps, PS prompting may be extended with more detailed instructions to derive “PS+” prompting.

Briefly, one particular implementation is directed to a method, comprising: responsive to a received first prompt, submitting a second prompt to one or more generative neural network models based, at least in part, on the first prompt, the second prompt specifying a plurality of computing tools for use in constructing the requested response. The second prompt may request an identification of tasks to be executed based, at least in part, on at least some of the plurality of computing tools and based, at least in part, on execution dependencies between and/or among the identified tasks. The method may further comprise receiving from the one or more generative neural network models, one or more second messages specifying the identified tasks and an order of execution of the identified tasks based, at least in part, on the dependency between and/or among the identified tasks.

In one aspect, leveraging one or more generative neural networks to specify tasks to be executed for servicing a computing request based, at least in part, on associated dependencies between and/or among the specified tasks may enable improved computation results with greater accuracy.

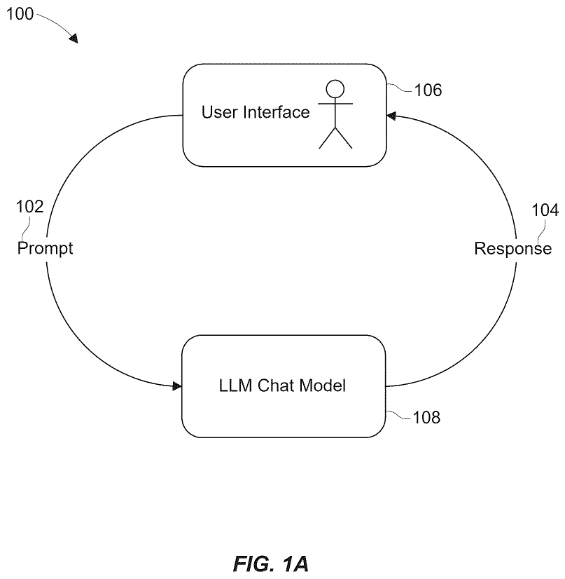

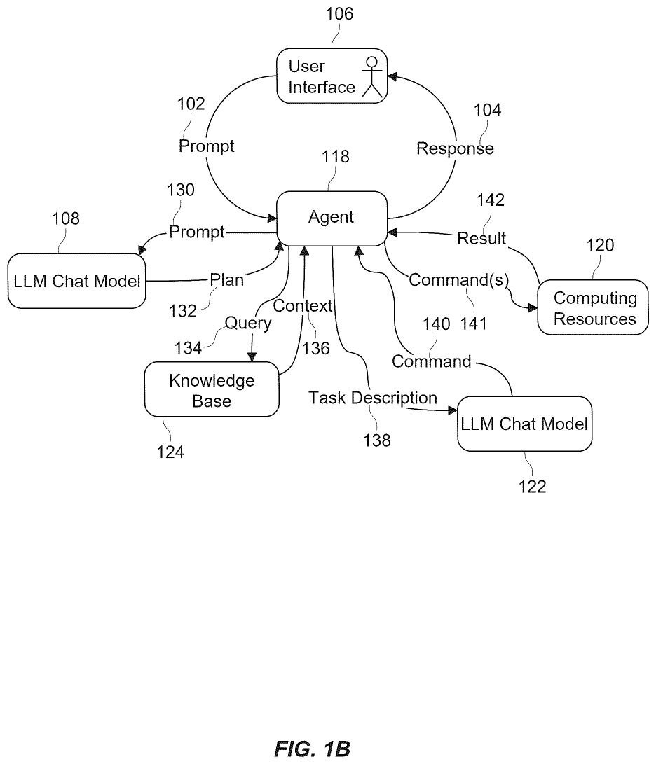

System 100 shown in FIG. 1A is directed a process for obtaining a computed response 104 in response to prompt 102. Here, a user interface 106 (e.g., graphical user interface (GUI)) at a computing device (not shown) may generate prompt 102 based, at least in part, on inputs received from an operator (not shown). In a particular implementation, user interface 106 may initiate transmission of one or more messages over a communication network to LLM Chat Model 108. Likewise, user interface 106 may receive computed response 104 in one or more messages transmitted over the communication network. LLM Chat Model 108 may comprise one or more hosted generative neural network models such as, for example ChatGPT, just to provide an example. As referred to herein, a “generative neural network model” means a combination of neural networks having parameters adapted to and/or trained for generation of content such as, for example, image, text, computer code (e.g., source code or pseudo code), natural language instructions and/or audio content, just to provide a few examples. Content generated by such a generative neural network model may be expressed electronically in one or more electrical signals (e.g., in a transmission medium or memory). In particular implementations, generative neural network models referred to herein may be configured from any one of several transformer models including LongT5-3B, MPT-7B, Llama2-7B or Llama2-14B, just to provide a few examples. All or portions of computational tasks for determining computed response 104 may be computed by LLM Chat Model 108 and/or other computing devices (not shown).

In the particular implementation of FIG. 1B, an agent 118 may be used to direct processing activities for providing computed response 104 to service a request of prompt 102. Based, at least in part, on prompt 102, agent 118 may determine individual computational tasks to formulate response 104. For example, agent 118 may decompose prompt 102 into multiple interrelated computing tasks for formulating response 104. In one aspect, agent 118 may submit a query 134 to a knowledge base 124, and receive context parameters 136. Agent 118 may at least in part formulate prompt 130 based, at least in part, on context parameters 136 received from knowledge base 134. In one implementation, context parameters 136 may be suggestive of how problems related to or similar to that of prompt 102 have been solved in the past. In another embodiment, context parameters may be suggestive of previous interaction of a user with LLM Chat Model 108 and/or 122. For example, context parameters 136 may be indicative of a result provided to service a previous prompt. Based, at least in part, on context parameters 136 and an identification of computing tools for use in implementing response 104, agent 118 may formulate prompt 130 to receive a plan 132 identifying computing tasks to be executed for computing result 104 to service prompt 102. According an embodiment, prompt 130 may further request that plan 132 specify an order of execution of the identified tasks based, at least in part, on a dependencies between and/or among the identified computing tasks.

Responsive to prompt 130, LLM Chat Model 108 may determine a detailed plan 132 for computing result 104. In one implementation, detailed plan 132 may identify specific computing resources for implementing response 104 such as, for example, specific computing resources to execute tasks associated with response 104. For example, plan 132 may specify executable computing modules and/or tools, how such specified executable computing modules and/or tasks are to be integrated, hardware computing resources and/or the like for constructing response 104. In a particular implementation, prompt 130 may include a natural language request for consideration of dependencies between and/or among tasks. As such, plan 132 may specify dependencies between and/or among tasks based on computing tools specified in prompt 130.

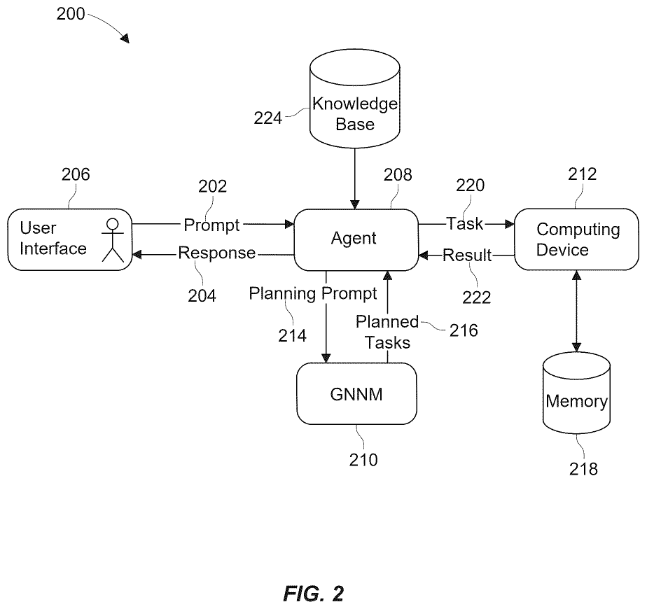

According to an embodiment, a process for obtaining a computed result in response to a prompt, such as processes described above in connection with system 100, may at least in part be implemented by system 200 shown in FIG. 2. In a particular implementation, agent 208 and user interface 206 may be hosted on the same or different computing devices. As pointed out above, agent 208 make communicate with generative neural network model (GNNM) 210 over a communication network, such as a communication network configured to transmit messages according to a suitable Internet Protocol. Additionally, generative neural network model 210 may comprise any one of several hosted LLM platforms including, for example, ChatGPT.

As pointed out above, agent 208 may process prompt 202 by, for example, deconstructing prompt 202 into tasks types and/or actions to be executed to obtain response 204. According to an embodiment, using parameters and/or history maintained in knowledge base 224 for example, agent 208 may formulate planning prompt 214 to be provided to generative neural network model 210. Based, at least in part, on planning prompt 214 (e.g., including natural language expressions of task types and/or actions to be taken), generative neural network model 210 may generate planned tasks 216. Planned tasks 216 may identify, for example, specific execution modules and/or hardware resources to be employed (e.g., how such specific modules and/or hardware resources are integrated) in implementing processing task types and/or actions to be taken as set forth in planning prompt 214.

In another scenario, execution of specific task type and/or actions to be taken in planning prompt 214 may rely on at least partial completion of a second task type and/or action to be taken specified in planning prompt 214. Likewise, execution of a first computing task identified in planned tasks 216 may rely on at least partial completion of a second computing task identified in planned tasks 216. As such, execution of the first computing task may “depend” on a result and/or state from the second computing task. According to an embodiment, planning prompt 214 may specify that GNNM 210 is to consider dependency between and/or among task types and/or actions to be taken, in addition to identifying execution modules to be implemented, planned tasks 216 may also specify interdependencies between and/or among the identified computing tasks. In one example, planned tasks 216 may specify an order of execution of different tasks (e.g., commencement of execution of a second computing task to occur after completion of execution of a first computing task). In another example, planned tasks 216 may specify linking particular results of execution of a first computing task as input values to a second computing task. In a particular implementation, planned tasks 216 may determine how specific formatted fields/data items of results of a first computing task are to map to specific formatted fields/data items results of a second computing task. It should be understood, however, that these are merely examples of dependencies between and/or among different execution modules for computation tasks, and claimed subject matter is not limited in this respect.

Based, at least in part, on planned tasks 216, agent 208 may initiate execution of tasks 220 at computing devices 212. In a particular implementation, tasks 220 may specify execution of computing tasks identified in plan tasks 216, for example. In one embodiment, prompt 202 may request generation of computer code for performing a particular computation task. Here, a task specified in planned tasks 216 may specify generation of a segment of that computer code (e.g., source code and/or executable code) to service prompt 202.

According to an embodiment, different computing tasks identified in tasks 220 may be executed by different computing devices, including different computing devices maintained and operated by different parties. In one embodiment, execution of tasks 220 at computing device 212 may, at least in part, control execution of modules/instructions identified in tasks 220 according to dependencies between and/or among the different execution modules. For example, agent 208 may delay initiating execution of a first task until completion a second computing task if, for example, first computing task is to use as an input be different in terms of a result from second execution of a computing task.

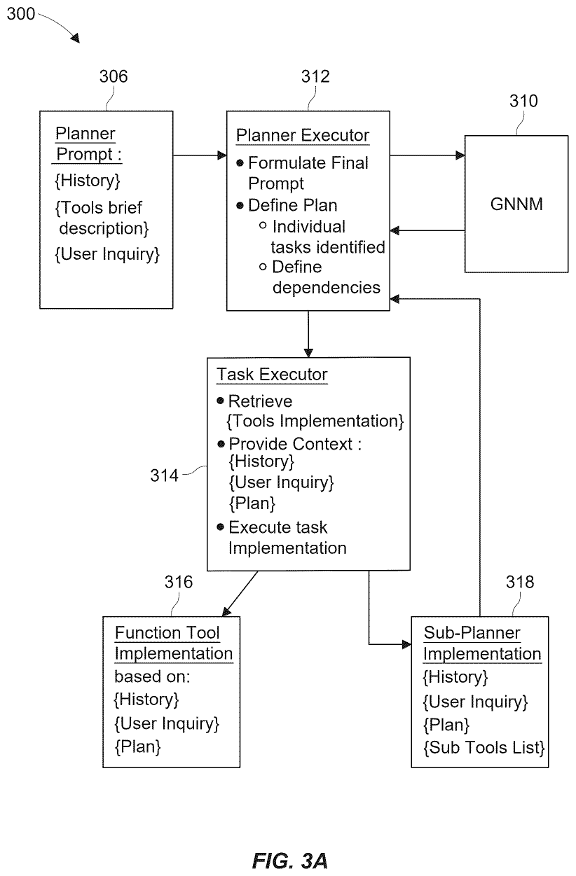

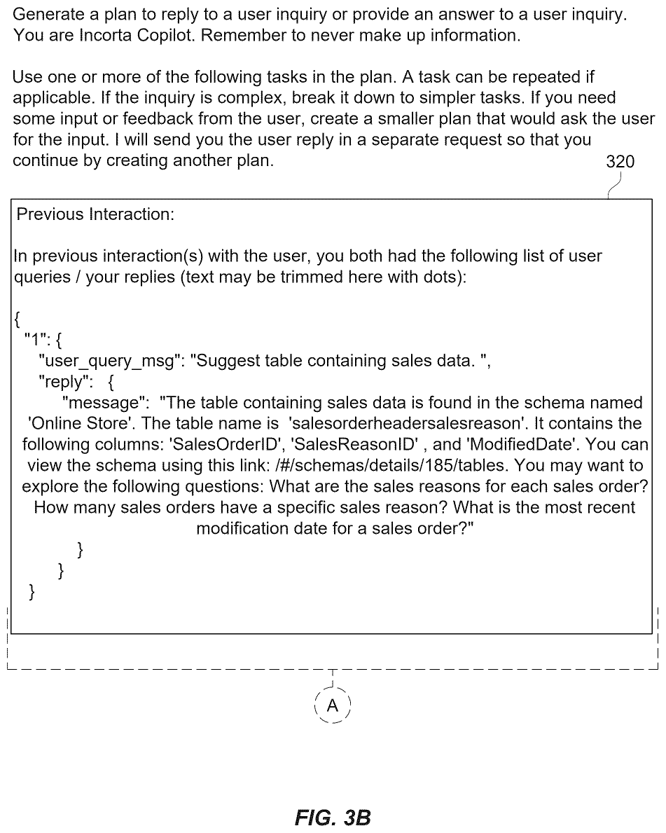

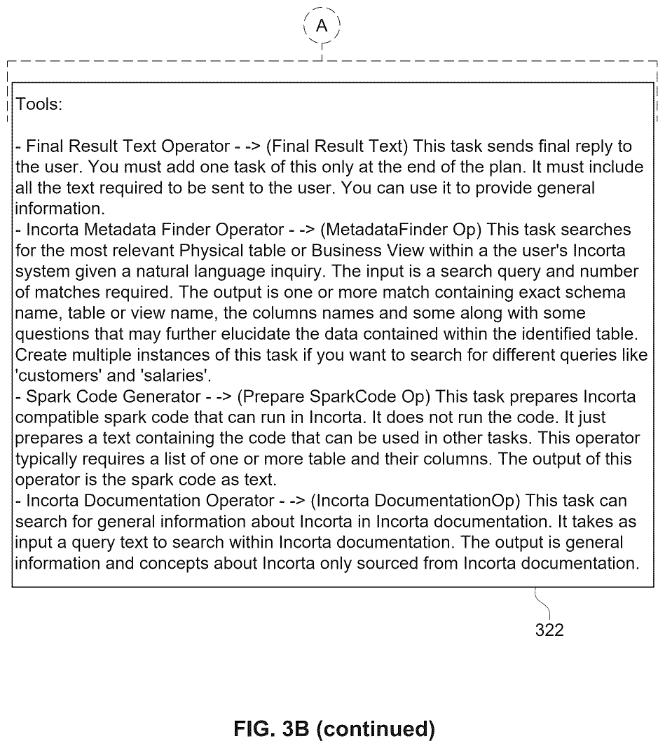

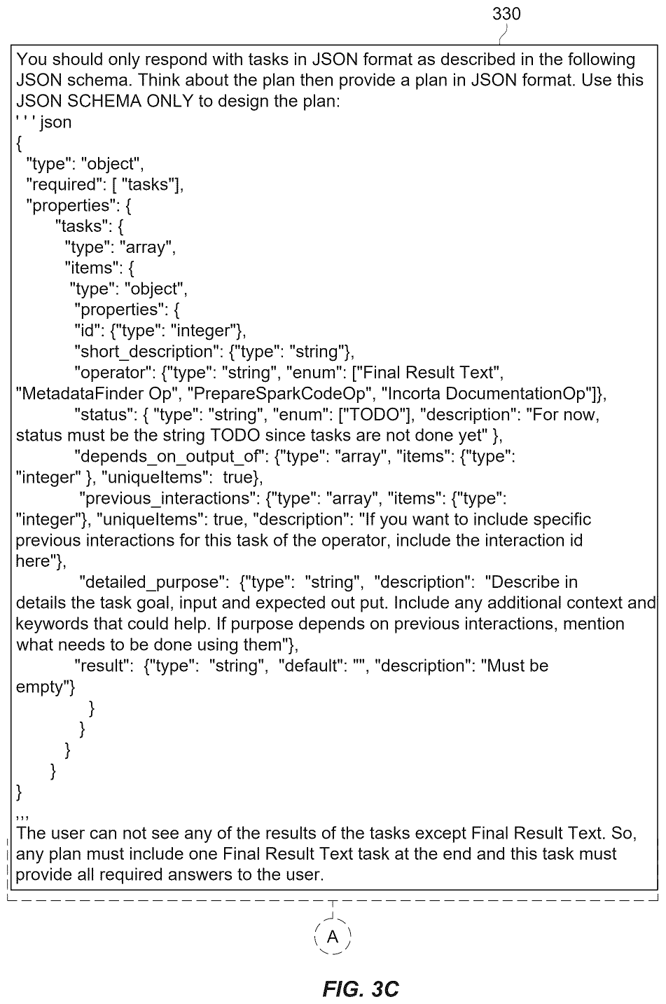

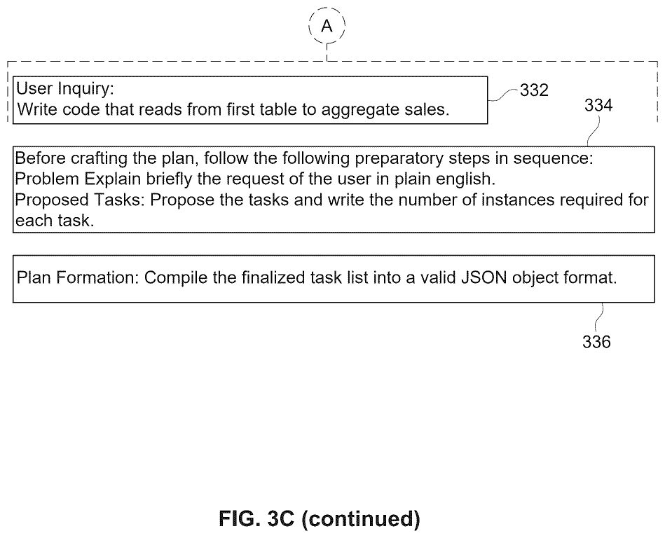

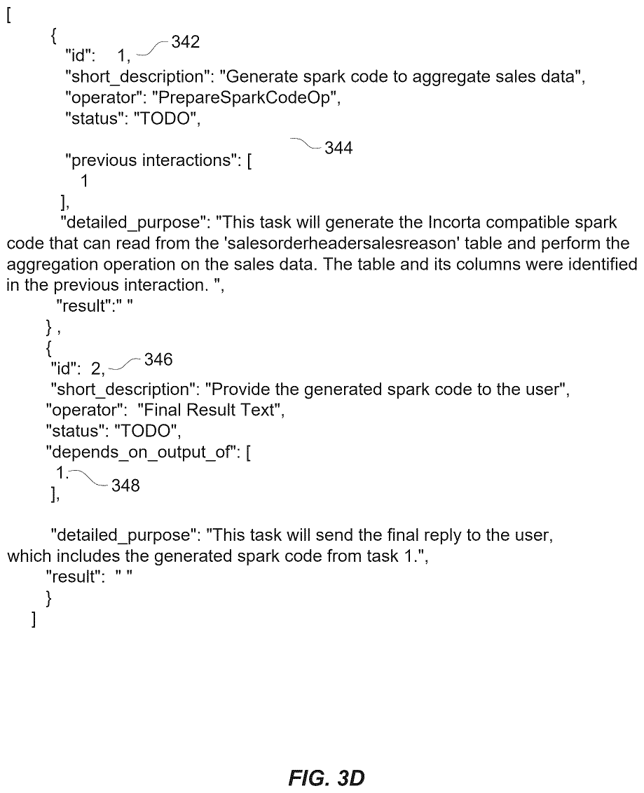

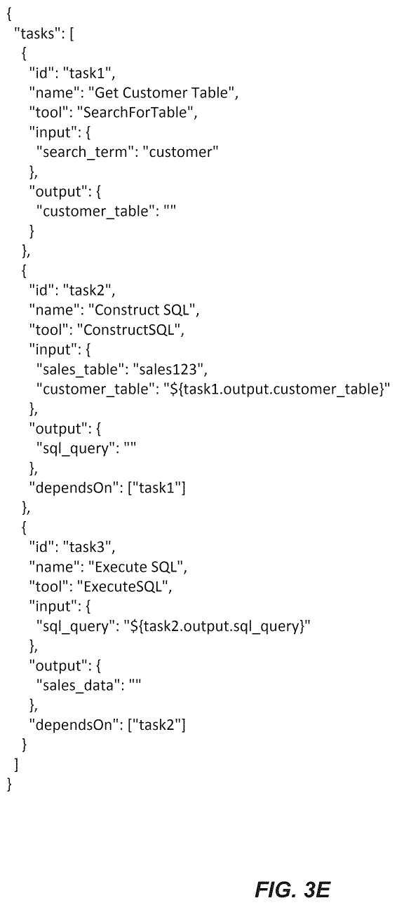

According to an embodiment, system 200 (FIG. 2) may be used to implement process 300 shown in FIG. 3A. Here, a desired function tool implementation 316 for satisfying a user inquiry {User Inquiry} may be based, at least in part, on a planner prompt 306. In a particular implementation, planner prompt 306 may be constructed to express parameters specified by a user according to a particular pre-specified format and/or template. In the particular illustrated embodiment, function tool implementation 316 may comprise an integration of execution modules to satisfy a user inquiry {User Inquiry} specified in planner prompt 306. In one particular example in which {User Inquiry} requests generation of computer code to perform a particular computation, function tool implementation 316 may comprise an integration of computing routines/modules (e.g., source code and/or executable code for generating the particular computation). It should be understood, however, that this is merely an example of a computing result that may be generated responsive to parameters specified in planner prompt 306 according to a template, and claimed subject matter is not limited in this respect.

In a particular implementation, planner prompt 306 may be submitted by a user through a user interface such as user interface 206. Based, at least in part, on parameters submitted in planner prompt 306 and additional parameters relating to an availability of computing tools listed in {Tools brief description}, planner executor 312 in combination with task executor 314 may generate function tool implementation 316, as an example. In one implementation, parameters relating to computing tools in {Tools brief description} may be obtained from knowledge base 224. In another implementation, actions of planner executor 312 and task executor 314 may be implemented, at least in part, by agent 208 (FIG. 2), for example.

In the presently illustrated embodiment, planner prompt 306 may express a history {History} of user interaction with planner executor 312, a brief description of tools and/or tasks to be used in computing and/or constructing a computing result {Tools brief description} and a user inquiry {User Inquiry}. In one example, parameters in {History} may express and/or specify previous user inquiries submitted to planner executor 312 and/or results computed and/or obtained (e.g., from task executor 314) responsive to such previous user inquiries. The particular example embodiments discussed herein parameters in {History} relate specifically to events surrounding a previous prompt submitted by a user. In other embodiments, parameters in history may comprise any parameters providing context for a previous user interaction (e.g., “conversation”) including, for example, automatically generated parameters in audit logs, parameters stored in a long-term memory identified as being relevant to a current interaction, just to provide a couple of examples. Parameters in {Tools brief description} may specify in natural language individual tasks and/or capabilities of identified therein.

In one particular implementation, parameters in {History} may be obtained from a memory local to and/or shared with a GUI used for user interaction (e.g., GUI 206). In another implementation, parameters in {History} may be obtained from a remote computing device (e.g., server).

FIG. 3B shows portions of an example natural language prompt formatted according to template, such as a template to form planner prompt 306. Here, parameters for {History} at 320 specify a previous user interaction (e.g., with agent 208 and/or generative neural network model 210) in connection with an initial inquiry/request “suggest table containing sales data,” which yielded the following result:

“The sale table we found is ‘salesperson’ from the ‘OnlineStore’ schema. The
‘salesperson’ table includes columns such as SalesPersonID, TerritoryID,
SalesQuota, Bonus, CommissionPct, SalesYTD, SalesLastYear, rowguid, and
ModifiedDate. The ‘salesorderheadersalesreason’ table includes columns such
as SalesOrderID, SalesReasonID, and ModifiedDate. You can ask questions like
‘What is the total sales quota for all salespersons?’, ‘Which salesperson has the
highest bonus?’, ‘How much commission did each salesperson earn last year?’
for the ‘salesperson’ table and ‘What are the sales reasons for each sales
order?’, ‘How many sales orders have a specific sales reason?’, ‘What is the
most recent modification date for a sales order?’ for the
‘salesorderheadersalesreason’ table.”

Parameters for {Tools brief description} may be specified at 322, identifying tools FinalResultText (“Final Result Text Operator”), MetadataFinderOp (“Incorta Metadata Finder Operator”), PrepareSparkCodeOp (“Spark Code Generator”) and IncortaDocumentationOp (“Incorta Documentation Operator”), with associated brief natural language descriptions. Based on a result of the initial inquiry/request, a subsequent follow up user inquiry {User Inquiry} for a prompt expressed in FIG. 3B may be expressed as “write code that reads from that table to aggregate sales.” To service the follow up user inquiry, the user may submit (e.g., through user interface 206) a prompt, such a prompt formatted according to planner prompt 306 shown in FIG. 3A, for example. Here, in responding to the subsequent follow up user inquiry, a generative neural network model (e.g., GNNM 310) may interpret “that table” as referring to a result from a previous interaction with the user to service aforementioned user inquiry “suggest table containing sales data yielding the following result: . . . .” For example, such a generative neural network model may interpret the phrase “that table” in the subsequent follow up user inquiry as a result of servicing the user inquiry “suggest table containing sales data yielding the following result: . . . .”

Based, at least in part, on a prompt received from a user (e.g., a prompt as expressed in FIG. 3B), an agent (e.g., agent 208) may formulate a finalized prompt to be presented to a generative neural network model (e.g., generative neural network model 310) for generating a detailed plan for satisfying the follow up user inquiry.

According to an embodiment, {Tools brief description} expressed in planner prompt 306 may not include specific details regarding how individual tools are to be integrated for providing a response to fully satisfy a request of {User Inquiry}. Based, at least in part, on additional implementation details of computing tools listed in {Tools brief description}, planner executor 312 may formulate a final prompt to be presented to generative neural network model 310 (e.g., generative neural network model 210).

As pointed out above, some computing tasks to service {User Inquiry} may execute concurrently, but that dependencies between and/or among individual tasks to satisfy {User Inquiry} may be suggestive of and/or require a particular order of execution of the individual tasks. For example, results of completion and/or completion state of one computing task among computing tasks to service {User Inquiry} may affect the execution of one or more other computing tasks among computing tasks to service {User Inquiry}. In a final prompt to be presented to generative neural network model 310, planner executor 312 may further characterize and/or specify that requested computing tasks to service {User Inquiry} are to be determined based, at least in part, on dependencies between and/or among computing tasks to be identified.

In one implementation, computing tools in {Tools brief description} may be indicative of and/or specify particular execution modules to implement corresponding tasks to service {User Inquiry} of planner prompt 306. For example, computing tools in {Tools brief description} may specify particular input and/or output values in particular fields, data types, etc. In a prompt to be submitted to GNNM 310, planner executor 312 may specify tools (e.g., execution modules) identified in {Tools brief description}. Such a prompt submitted to GNNM 310 from planner executor 312 may also include parameters expressed in planner prompt 306 including {History}, {Tools brief description} and {User Inquiry}, for example.

Responsive to a prompt from planner executor 312, GNNM 310 may generate output content including, for example, a plan {Plan} to be executed for servicing {User Inquiry} specified in planner prompt 306. In the particular example of {User Inquiry} specifying “write code that reads from first table to aggregate sales,” portions of {Plan} may be as shown in FIG. 3D. Such a plan specifies two computing tasks to incorporate two execution modules: a first execution module 342 (“Generate spark code to aggregate sales data”) using tool PrepareSparkCodeOp (having “id” 1) and a second execution module 346 (“Provide the generated spark code to the user”) using tool FinalResultText. It may be observed that tools PrepareSparkCodeOp and FinalResultText are specified in tools listed in 322 (FIG. 3B).

As may be observed, consistent with dependencies, plan {Plan} shown in FIG. 3D specifies dependencies 344 and 348 of computing tasks 342 and 344, respectively. Here, dependency 344 specifies that execution of computing task 342 is not dependent on completion of execution of any other computing task identified in plan {Plan}. Conversely, dependency 348 specifies that execution computing task 346 is dependent on completion of execution of compute task 342 (i.e., having “id” 1). Additionally, as indicated by note 345, a generated sales “table and its columns were identified in the previous interaction.” In this particular example, the table and its columns “identified in the previous interaction” may be obtained from {History} (FIG. 3A).

In another example, planner executor 312 may present a prompt to GNNM 310 that further species that plan {Plan} is to be in a particular format (e.g., JSON), such as in the following example natural language prompt:

Create a plan of tasks to answer user inquiry: Run sql to get sales data joined
with customers? Construct the plan given the tools: * SearchForTable *
ConstructSQL * ExecuteSQL Given a history chat with user where: User: What is
the name of the sales tables? You: it is sales123 Create the plan as list of tasks
in json and add dependency among tasks and add dependency on the history
items if required

Responsive to the prompt quoted above, GNNM 310 may return a plan {Plan} as shown in FIG. 3E. As may be observed, the prompt specifies a user inquiry {User Inquiry} as “Run sql to get sales data joined with customers?” using three available computing tools {Tools List}: SearchForTable; ConstructSQL and ExecuteSQL. A history {History} of a user's previous interaction is introduced as a user's previous prompt “What is the name of the sales tables?” and a corresponding response to the previous prompt from GNNM 310 as “it is sales 123.” Additionally, the prompt above further specifies dependency between and/or among tasks as “add dependency among tasks and add dependency on the history items if required.”

As may be observed from the plan shown in FIG. 3E, a resulting plan {Plan} from the prompt above identifies tasks “task1” (for deploying tool SearchForTable), “task2” (for deploying ConstructSQL), “task3” (for deploying tool ExecuteSQL). Additionally, as per “and add dependency among tasks” set forth in the prompt, the plan shown in FIG. 3E further specifies that “task2” “dependsOn”:[“task1” ], and that “task3” “dependsOn”:[“task1” ].

Based, at least in part, on plan {Plan} generated by GNNM 310, task executor 314 may implement plan {Plan} as function tool implementation 316 on one or more computing devices (e.g., computing devices 212). For example, {Tools Implementation} may include executable images and/or locators to executable images to be configured and hosted on computing devices consistent with plan {Plan}. In one particular implementation, executable images in {Tools Implementation} may include executable coded organized as executable modules and/or routines. In another particular implementation, locators in {Tools Implementation} may include universal resource locators (URLs) and/or universal resource indicators (URIs) enabling access to a service capable of executing computations, for example.

According to an embodiment, in the course of constructing function tool implementation 316 according to plan {Plan}, task executor 314 may encounter a tool and/or task identified in plan {Plan} that may be partitioned and/or executed by multiple sub-tools/sub-tasks. Here, task executor 314 may initiate a nested process by creation of a sub-planner implementation 318 that may specify parameters for one or more additional prompts to be submitted to a generative neural network model. In addition to parameters in {History} and {User Inquiry} specified in planner prompt template 306, and {Plan} produced by generative neural network model 310, sub-planner implementation 318 may specify computing tools in {Sub Tools List} that may be used for implementing a particular “nested” tool specified in plan {Plan}. Based, at least in part, on sub-planner implementation 318, planner executor 312 may formulate an additional prompt to be submitted to a generative neural network to produce a sub-plan {Plan} to be used in implementing tools for the nested plan. In one implementation, planner executor 312 may submit the additional prompt (based on sub-planner implementation 318) to the same GNNM (e.g., GNNM 310). In another implementation, planner executor 312 may have the flexibility to intelligently submit the additional prompt (based on sub-planner implementation 318) to a different GNNM better suited for determining a sub-plan {Plan} (e.g., may be less costly or more effective) for a particular nested tool.

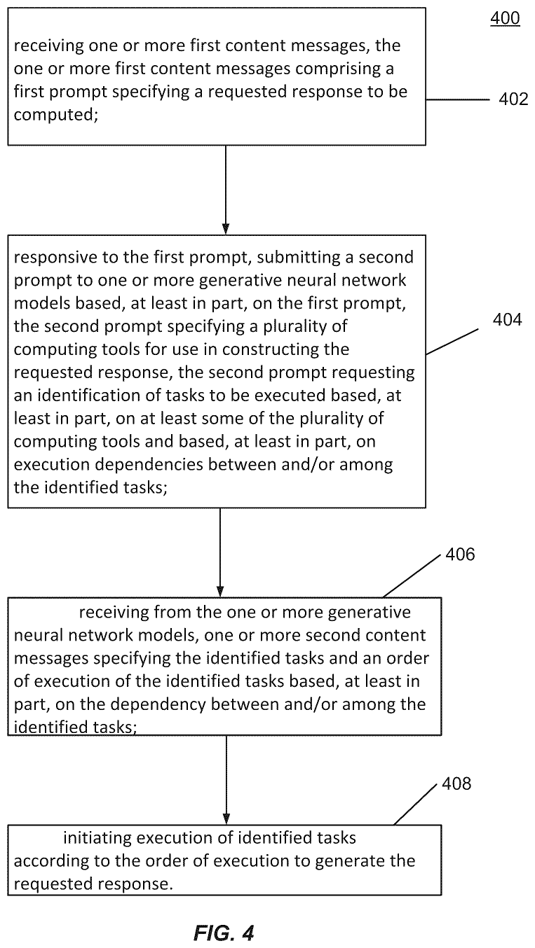

FIG. 4 is a flow diagram of a process 400 to identify tasks to service a prompt, according to an embodiment. Block 402 comprises receipt (e.g., from a user interface) of one or more messages comprising a first prompt, such as prompt 102 or 202, for example. Messages received at block 402 may originate at a user interface such as user interface 106 and/or 206, for example. Messages received at block 402 may include signal content in any one of several formats used to electronically express text, audio, visual, heat, light, pressure, just to provide a few examples content that may be contained in messages received at block 402. Responsive to the first prompt, block 404 may submit a second prompt (e.g., via planner executor 312) to one or more generative neural networks (e.g., generative neural network models 210 or 310). The second prompt may specify a plurality of computing tools for construction a response to the first prompt. The second prompt may request an identification of tasks to be executed based, at least in part, on at least some of the plurality of computing tools and based, at least in part, on execution dependencies between and/or among the identified tasks.

As discussed above in reference to a particular example embodiment, computing tools specified in a second prompt may comprise computer instructions organized in execution modules that are cataloged in a library of execution modules. In a particular implementation, the first prompt may comprise a natural language description and/or identification of execution modules to be used as computing tools. In another particular implementation, such a natural language description and/or identification of execution modules may include a specification of input values and/or output values corresponding to respective identified execution modules. In yet another particular implementation, such a natural language description and/or identification of execution modules may omit reference to input values and/or output values corresponding to respective identified execution modules.

Responsive to the second prompt, the one or more generative neural network models may specify an order of execution of identified tasks based, at least in part, on a dependency between and/or among identified tasks in a plan such as plan {Plan} provided by generative neural network model 310. By specifying in a prompt to the one or more generative neural network models that dependencies between and/or among tasks are to be considered, a resulting plan may be better integrated and organized, and require less additional modification by a user. Block 406 may comprise receiving a plan generated by the one or more generative neural network models, such as a plan specifying identified tasks and/or an order of execution of the identified tasks based, at least in part, on the dependency between and/or among the identified tasks. Finally, block 408 may comprise executing tasks according to a plan received at block 406 (e.g., via task executor 314). Additionally, a first prompt in a message received at block 402 and/or second prompt submitted at block 404 may specify one or more previous interactions of the user with the generative neural network model, such as making reference to a result of servicing a previous prompt. Task identified and/or order of execution identified of the identified tasks may then be further based, at least in part, on the specified one or more previous interactions. According to an embodiment, the second submitted in block 404 may further specify at least some dependencies between and/or among computing tools for constructing a requested response. In the particular example of FIG. 3A, a final prompt formulated by planner executor 312 may specify dependencies among at least some computing tools identified in {Tools brief description}.

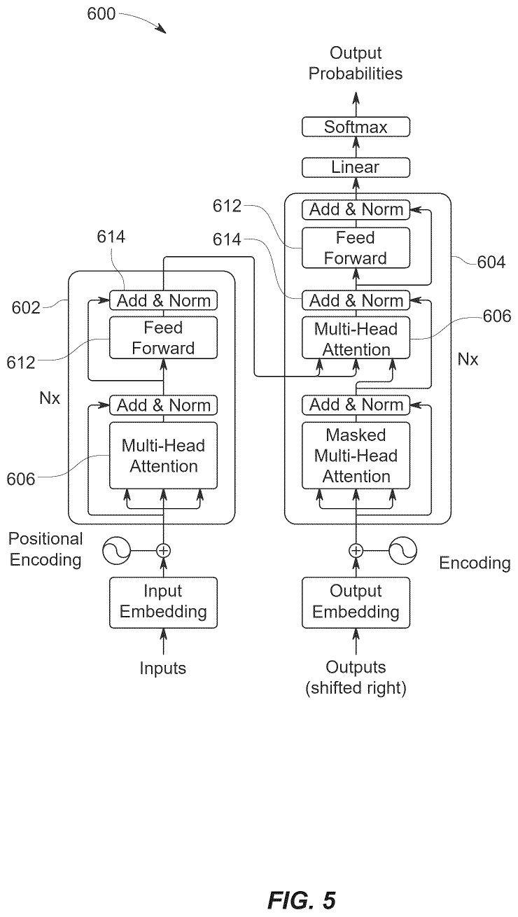

According to an embodiment, generative neural network models 210 and 310 may be configured as a natural language processing (NLP) model, such as LLMs powered by versions of a GPT available through OpenAI including, for example, ChatGPT, MosaicML or LongT5, just to provide a few examples. FIG. 5 is a schematic diagram of a generative neural network model 600 such as an implementation of ChatGPT, for example. In one implementation, inputs may comprise a series of words that are preprocessed (e.g., converted to numbers or other input vectors) and provided in sequence to generate output probabilities of a subsequent word. Once the subsequent word is determined, the subsequent word may be combined with the input so that the next subsequent word may be determined, causing the ChatGPT system to repeatedly predict a next word in a response to a prompt. In one implementation, an input sequence may be fixed at some value, such as 2048 words, and extra positions at the beginning may be padded with zeros. An output may similarly comprise an array of possible outcomes with associated probabilities, such that the most probable subsequent word may be selected as the next word in the response or output.

Because input vectors in this particular example may indicate only a single word and comprise many more zeros than ones (e.g., ChatGPT has a vocabulary of over 50,000 input words and associated vectors), the input vectors may be embedded or encoded into a smaller multidimensional space at an input embedding element. The position of each resulting token in a sequence of inputs may be encoded and provided to a multi-head attention element 606 operable to predict a degree to which an input token is likely to impact an output. Feed-forward blocks 612 may each comprise a multi-layer neural network, operable to learn over time to predict the next word in a sequence. An add & norm block 614 may combine and normalize outputs of multiple previous blocks.

In the context of the present patent application, the term “connection,” the term “component” and/or similar terms are intended to be physical, but are not necessarily always tangible. Whether or not these terms refer to tangible subject matter, thus, may vary in a particular context of usage. As an example, a tangible connection and/or tangible connection path may be made, such as by a tangible, electrical connection, such as an electrically conductive path comprising metal or other conductor, that is able to conduct electrical current between two tangible components. Likewise, a tangible connection path may be at least partially affected and/or controlled, such that, as is typical, a tangible connection path may be open or closed, at times resulting from influence of one or more externally derived signals, such as external currents and/or voltages, such as for an electrical switch. Non-limiting illustrations of an electrical switch include a transistor, a diode, etc. However, a “connection” and/or “component,” in a particular context of usage, likewise, although physical, can also be non-tangible, such as a connection between a client and a server over a network, particularly a wireless network, which generally refers to the ability for the client and server to transmit, receive, and/or exchange communications, as discussed in more detail later.

In a particular context of usage, such as a particular context in which tangible components are being discussed, therefore, the terms “coupled” and “connected” are used in a manner so that the terms are not synonymous. Similar terms may also be used in a manner in which a similar intention is exhibited. Thus, “connected” is used to indicate that two or more tangible components and/or the like, for example, are tangibly in direct physical contact. Thus, using the previous example, two tangible components that are electrically connected are physically connected via a tangible electrical connection, as previously discussed. However, “coupled,” is used to mean that potentially two or more tangible components are tangibly in direct physical contact. Nonetheless, “coupled” is also used to mean that two or more tangible components and/or the like are not necessarily tangibly in direct physical contact, but are able to co-operate, liaise, and/or interact, such as, for example, by being “optically coupled.” Likewise, the term “coupled” is also understood to mean indirectly connected. It is further noted, in the context of the present patent application, since memory, such as a memory component and/or memory states, is intended to be non-transitory, the term physical, at least if used in relation to memory necessarily implies that such memory components and/or memory states, continuing with the example, are tangible.

Unless otherwise indicated, in the context of the present patent application, the term “or” if used to associate a list, such as A, B, or C, is intended to mean A, B, and C, here used in the inclusive sense, as well as A, B, or C, here used in the exclusive sense. With this understanding, “and” is used in the inclusive sense and intended to mean A, B, and C; whereas “and/or” can be used in an abundance of caution to make clear that all of the foregoing meanings are intended, although such usage is not required. In addition, the term “one or more” and/or similar terms is used to describe any feature, structure, characteristic, and/or the like in the singular, “and/or” is also used to describe a plurality and/or some other combination of features, structures, characteristics, and/or the like. Likewise, the term “based on” and/or similar terms are understood as not necessarily intending to convey an exhaustive list of factors, but to allow for existence of additional factors not necessarily expressly described.

The terms “correspond”, “reference”, “associate”, and/or similar terms relate to signals, signal samples and/or states, e.g., components of a signal measurement vector, which may be stored in memory and/or employed with operations to generate results, depending, at least in part, on the above-mentioned, signal samples and/or signal sample states. For example, a signal sample measurement vector may be stored in a memory location and further referenced wherein such a reference may be embodied and/or described as a stored relationship. A stored relationship may be employed by associating (e.g., relating) one or more memory addresses to one or more another memory addresses, for example, and may facilitate an operation, involving, at least in part, a combination of signal samples and/or states stored in memory, such as for processing by a processor and/or similar device, for example. Thus, in a particular context, “associating,” “referencing,” and/or “corresponding” may, for example, refer to an executable process of accessing memory contents of two or more memory locations, e.g., to facilitate execution of one or more operations among signal samples and/or states, wherein one or more results of the one or more operations may likewise be employed for additional processing, such as in other operations, or may be stored in the same or other memory locations, as may, for example, be directed by executable instructions. Furthermore, terms “fetching” and “reading” or “storing” and “writing” are to be understood as interchangeable terms for the respective operations, e.g., a result may be fetched (or read) from a memory location; likewise, a result may be stored in (or written to) a memory location.

It is further noted that the terms “type” and/or “like,” if used, such as with a feature, structure, characteristic, and/or the like, using “optical” or “electrical” as simple examples, means at least partially of and/or relating to the feature, structure, characteristic, and/or the like in such a way that presence of minor variations, even variations that might otherwise not be considered fully consistent with the feature, structure, characteristic, and/or the like, do not in general prevent the feature, structure, characteristic, and/or the like from being of a “type” and/or being “like,” (such as being an “optical-type” or being “optical-like,” for example) if the minor variations are sufficiently minor so that the feature, structure, characteristic, and/or the like would still be considered to be substantially present with such variations also present. Thus, continuing with this example, the terms optical-type and/or optical-like properties are necessarily intended to include optical properties. Likewise, the terms electrical-type and/or electrical-like properties, as another example, are necessarily intended to include electrical properties. It should be noted that the specification of the present patent application merely provides one or more illustrative examples and claimed subject matter is intended to not be limited to one or more illustrative examples; however, again, as has always been the case with respect to the specification of a patent application, particular context of description and/or usage provides helpful guidance regarding reasonable inferences to be drawn.

With advances in technology, it has become more typical to employ distributed computing and/or communication approaches in which portions of a process, such as signal processing of signal samples, for example, may be allocated among various devices, including one or more client devices and/or one or more server devices, via a computing and/or communications network, for example. A network may comprise two or more devices, such as network devices and/or computing devices, and/or may couple devices, such as network devices and/or computing devices, so that signal communications, such as in the form of signal packets and/or signal frames (e.g., comprising one or more signal samples), for example, may be exchanged, such as between a server device and/or a client device, as well as other types of devices, including between wired and/or wireless devices coupled via a wired and/or wireless network, for example.

In the context of the present patent application, the term network device refers to any device capable of communicating via and/or as part of a network and may comprise a computing device. While network devices may be capable of communicating signals (e.g., signal packets and/or frames), such as via a wired and/or wireless network, they may also be capable of performing operations associated with a computing device, such as arithmetic and/or logic operations, processing and/or storing operations (e.g., storing signal samples), such as in memory as tangible, physical memory states, and/or may, for example, operate as a server device and/or a client device in various embodiments. Network devices capable of operating as a server device, a client device and/or otherwise, may include, as examples, dedicated rack-mounted servers, desktop computers, laptop computers, set top boxes, tablets, netbooks, smart phones, wearable devices, integrated devices combining two or more features of the foregoing devices, and/or the like, or any combination thereof. As mentioned, signal packets and/or frames, for example, may be exchanged, such as between a server device and/or a client device, as well as other types of devices, including between wired and/or wireless devices coupled via a wired and/or wireless network, for example, or any combination thereof. It is noted that the terms, server, server device, server computing device, server computing platform and/or similar terms are used interchangeably. Similarly, the terms client, client device, client computing device, client computing platform and/or similar terms are also used interchangeably. While in some instances, for ease of description, these terms may be used in the singular, such as by referring to a “client device” or a “server device,” the description is intended to encompass one or more client devices and/or one or more server devices, as appropriate. Along similar lines, references to a “database” are understood to mean, one or more databases and/or portions thereof, as appropriate.

A network may also include now known, and/or to be later developed arrangements, derivatives, and/or improvements, including, for example, past, present and/or future mass storage, such as network attached storage (NAS), a storage area network (SAN), and/or other forms of device readable media, for example. A network may include a portion of the Internet, one or more local area networks (LANs), one or more wide area networks (WANs), wire-line type connections, wireless type connections, other connections, or any combination thereof. Thus, a network may be worldwide in scope and/or extent. Likewise, sub-networks, such as may employ differing architectures and/or may be substantially compliant and/or substantially compatible with differing protocols, such as network computing and/or communications protocols (e.g., network protocols), may interoperate within a larger network.

The Internet refers to a decentralized global network of interoperable networks that comply with the Internet Protocol (IP). It is noted that there are several versions of the Internet Protocol. The term Internet Protocol, IP, and/or similar terms are intended to refer to any version, now known and/or to be later developed. The Internet includes local area networks (LANs), wide area networks (WANs), wireless networks, and/or long haul public networks that, for example, may allow signal packets and/or frames to be communicated between LANs. The term World Wide Web (WWW or Web) and/or similar terms may also be used, although it refers to a part of the Internet that complies with the Hypertext Transfer Protocol (HTTP). For example, network devices may engage in an HTTP session through an exchange of appropriately substantially compatible and/or substantially compliant signal packets and/or frames. It is noted that there are several versions of the Hypertext Transfer Protocol. The term Hypertext Transfer Protocol, HTTP, and/or similar terms are intended to refer to any version, now known and/or to be later developed. It is likewise noted that in various places in this document substitution of the term Internet with the term World Wide Web (“Web”) may be made without a significant departure in meaning and may, therefore, also be understood in that manner if the statement would remain correct with such a substitution.

The term electronic file and/or the term electronic document are used throughout this document to refer to a set of stored memory states and/or a set of physical signals associated in a manner so as to thereby at least logically form a file (e.g., electronic) and/or an electronic document. That is, it is not meant to implicitly reference a particular syntax, format and/or approach used, for example, with respect to a set of associated memory states and/or a set of associated physical signals. If a particular type of file storage format and/or syntax, for example, is intended, it is referenced expressly. It is further noted an association of memory states, for example, may be in a logical sense and not necessarily in a tangible, physical sense. Thus, although signal and/or state components of a file and/or an electronic document, for example, are to be associated logically, storage thereof, for example, may reside in one or more different places in a tangible, physical memory, in an embodiment.

A Hyper Text Markup Language (“HTML”), for example, may be utilized to specify digital content and/or to specify a format thereof, such as in the form of an electronic file and/or an electronic document, such as a Web page, Web site, etc., for example. An Extensible Markup Language (“XML”) may also be utilized to specify digital content and/or to specify a format thereof, such as in the form of an electronic file and/or an electronic document, such as a Web page, Web site, etc., in an embodiment. Of course, HTML and/or XML are merely examples of “markup” languages, provided as non-limiting illustrations. Furthermore, HTML and/or XML are intended to refer to any version, now known and/or to be later developed, of these languages. Likewise, claimed subject matter are not intended to be limited to examples provided as illustrations, of course.

In the context of the present patent application, the terms “entry,” “electronic entry,” “document,” “electronic document,” “content,”, “digital content,” “item,” and/or similar terms are meant to refer to signals and/or states in a physical format, such as a digital signal and/or digital state format, e.g., that may be perceived by a user if displayed, played, tactilely generated, etc. and/or otherwise executed by a device, such as a digital device, including, for example, a computing device, but otherwise might not necessarily be readily perceivable by humans (e.g., if in a digital format). Likewise, in the context of the present patent application, digital content provided to a user in a form so that the user is able to readily perceive the underlying content itself (e.g., content presented in a form consumable by a human, such as hearing audio, feeling tactile sensations and/or seeing images, as examples) is referred to, with respect to the user, as “consuming” digital content, “consumption” of digital content, “consumable” digital content and/or similar terms. In another embodiment, an electronic document, electronic content and/or digital content may comprise text, audio and/or image content formatted to be processed by a generative neural network model, or text, audio and/or image content generated by a generative neural network model. For one or more embodiments, an electronic document and/or an electronic file may comprise a Web page of code (e.g., computer instructions) in a markup language executed or to be executed by a computing and/or networking device, for example. In another embodiment, an electronic document and/or electronic file may comprise a portion and/or a region of a Web page. However, claimed subject matter is not intended to be limited in these respects.

Also, for one or more embodiments, an electronic document and/or electronic file may comprise a number of components. As previously indicated, in the context of the present patent application, a component is physical, but is not necessarily tangible. As an example, components with reference to an electronic document and/or electronic file, in one or more embodiments, may comprise text, for example, in the form of physical signals and/or physical states (e.g., capable of being physically displayed). Typically, memory states, for example, comprise tangible components, whereas physical signals are not necessarily tangible, although signals may become (e.g., be made) tangible, such as if appearing on a tangible display, for example, as is not uncommon. Also, for one or more embodiments, components with reference to an electronic document and/or electronic file may comprise a graphical object, such as, for example, an image, such as a digital image, and/or sub-objects, including attributes thereof, which, again, comprise physical signals and/or physical states (e.g., capable of being tangibly displayed). In an embodiment, digital content may comprise, for example, text, images, audio, video, and/or other types of electronic documents and/or electronic files, including portions thereof, for example.

Also, in the context of the present patent application, the term parameters (e.g., one or more parameters) refer to material descriptive of a collection of signal samples, such as one or more electronic documents and/or electronic files, and exist in the form of physical signals and/or physical states, such as memory states. For example, one or more parameters, such as referring to an electronic document and/or an electronic file comprising an image, may include, as examples, time of day at which an image was captured, latitude and longitude of an image capture device, such as a camera, for example, etc. In another example, one or more parameters relevant to digital content, such as digital content comprising a technical article, as an example, may include one or more authors, for example. Claimed subject matter is intended to embrace meaningful, descriptive parameters in any format, so long as the one or more parameters comprise physical signals and/or states, which may include, as parameter examples, collection name (e.g., electronic file and/or electronic document identifier name), technique of creation, purpose of creation, time and date of creation, logical path if stored, coding formats (e.g., type of computer instructions, such as a markup language) and/or standards and/or specifications used so as to be protocol compliant (e.g., meaning substantially compliant and/or substantially compatible) for one or more uses, and so forth.

Signal packet communications and/or signal frame communications, also referred to as signal packet transmissions and/or signal frame transmissions (or merely “signal packets” or “signal frames”), may be communicated between nodes of a network, where a node may comprise one or more network devices and/or one or more computing devices, for example. As an illustrative example, but without limitation, a node may comprise one or more sites employing a local network address, such as in a local network address space. Likewise, a device, such as a network device and/or a computing device, may be associated with that node. It is also noted that in the context of this patent application, the term “transmission” is intended as another term for a type of signal communication that may occur in any one of a variety of situations. Thus, it is not intended to imply a particular directionality of communication and/or a particular initiating end of a communication path for the “transmission” communication. For example, the mere use of the term in and of itself is not intended, in the context of the present patent application, to have particular implications with respect to the one or more signals being communicated, such as, for example, whether the signals are being communicated “to” a particular device, whether the signals are being communicated “from” a particular device, and/or regarding which end of a communication path may be initiating communication, such as, for example, in a “push type” of signal transfer or in a “pull type” of signal transfer. In the context of the present patent application, push and/or pull type signal transfers are distinguished by which end of a communications path initiates signal transfer.

Thus, a signal packet and/or frame may, as an example, be communicated via a communication channel and/or a communication path, such as comprising a portion of the Internet and/or the Web, from a site via an access node coupled to the Internet or vice-versa. Likewise, a signal packet and/or frame may be forwarded via network nodes to a target site coupled to a local network, for example. A signal packet and/or frame communicated via the Internet and/or the Web, for example, may be routed via a path, such as either being “pushed” or “pulled,” comprising one or more gateways, servers, etc. that may, for example, route a signal packet and/or frame, such as, for example, substantially in accordance with a target and/or destination address and availability of a network path of network nodes to the target and/or destination address. Although the Internet and/or the Web comprise a network of interoperable networks, not all of those interoperable networks are necessarily available and/or accessible to the public.

A network and/or sub-network, in an embodiment, may communicate via signal packets and/or signal frames, such as via participating digital devices and may be substantially compliant and/or substantially compatible with, but is not limited to, now known and/or to be developed, versions of any of the following network protocol stacks: ARCNET, AppleTalk, ATM, Bluetooth, DECnet, Ethernet, FDDI, Frame Relay, HIPPI, IEEE 1394, IEEE 802.11, IEEE-488, Internet Protocol Suite, IPX, Myrinet, OSI Protocol Suite, OsNet, RS-232, SPX, System Network Architecture, Token Ring, USB, and/or X.25. A network and/or sub-network may employ, for example, a version, now known and/or later to be developed, of the following: TCP/IP, UDP, DECnet, NetBEUI, IPX, AppleTalk and/or the like. Versions of the Internet Protocol (IP) may include IPv4, IPv6, and/or other later to be developed versions.

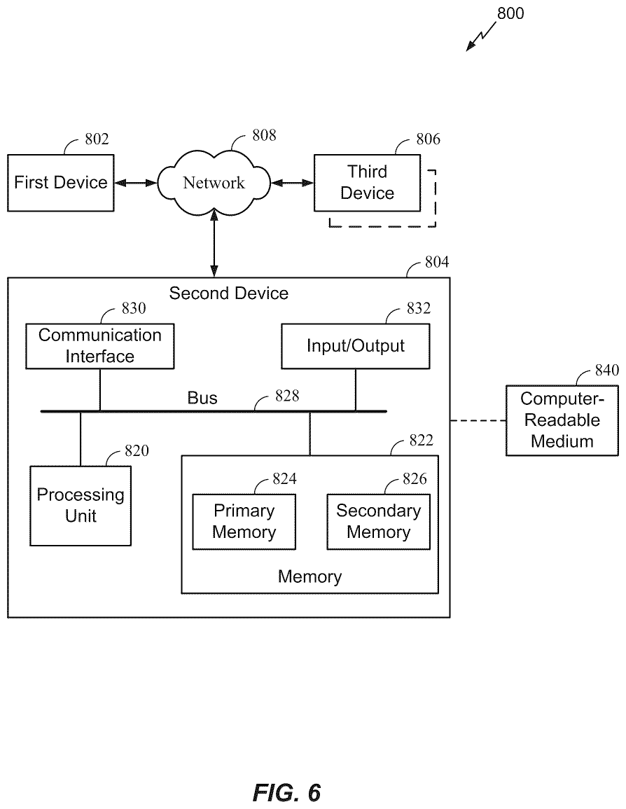

In one example embodiment, as shown in FIG. 6, a system embodiment may comprise a local network (e.g., device 804 and medium 840) and/or another type of network, such as a computing and/or communications network. For purposes of illustration, therefore, FIG. 6 shows an embodiment 800 of a system that may be employed to implement either type or both types of networks. Network 808 may comprise one or more network connections, links, processes, services, applications, and/or resources to facilitate and/or support communications, such as an exchange of communication signals, for example, between a computing device, such as 802, and another computing device, such as 806, which may, for example, comprise one or more client computing devices and/or one or more server computing device. By way of example, but not limitation, network 808 may comprise wireless and/or wired communication links, telephone and/or telecommunications systems, Wi-Fi networks, WiMAX networks, the Internet, a local area network (LAN), a wide area network (WAN), or any combinations thereof.

Example devices in FIG. 6 may comprise features, for example, of a client computing device and/or a server computing device, in an embodiment. It is further noted that the term computing device, in general, whether employed as a client and/or as a server, or otherwise, refers at least to a processor and a memory connected by a communication bus. A “processor,” for example, is understood to connote a specific structure such as a central processing unit (CPU) of a computing device which may include a control unit and an execution unit. In an aspect, a processor may comprise a device that fetches, interprets and executes instructions to process input signals to provide output signals. As such, in the context of the present patent application at least, computing device and/or processor are understood to refer to sufficient structure within the meaning of 35 USC § 112 (f) so that it is specifically intended that 35 USC § 112 (f) not be implicated by use of the term “computing device,” “processor” and/or similar terms, however, if it is determined, for some reason not immediately apparent, that the foregoing understanding cannot stand and that 35 USC § 112 (f), therefore, necessarily is implicated by the use of the term “computing device.” “processor” and/or similar terms, then, it is intended, pursuant to that statutory section, that corresponding structure, material and/or acts for performing one or more functions be understood and be interpreted to be described at least in FIGS. 1A, 1B, 2, 3A and 4 in the text associated with the foregoing figure(s) of the present patent application.

Referring now to FIG. 6, in an embodiment, first and third devices 802 and 806 may be capable of rendering a graphical user interface (GUI) (e.g., including a pointer device) for a network device and/or a computing device, for example, so that a user-operator may engage in system use. Computing device 804 may potentially serve a similar function in this illustration. Likewise, in FIG. 6, computing device 802 (‘first device’ in figure) may interface with computing device 804 (‘second device’ in figure), which may, for example, also comprise features of a client computing device and/or a server computing device, in an embodiment. Processor (e.g., processing device) 820 and memory 822, which may comprise primary memory 824 and secondary memory 826, may communicate by way of a communication bus 815, for example. The term “computing device,” in the context of the present patent application, refers to a system and/or a device, such as a computing apparatus, that includes a capability to process (e.g., perform computations) and/or store digital content, such as electronic files, electronic documents, measurements, text, images, video, audio, etc. in the form of signals and/or states. Thus, a computing device, in the context of the present patent application, may comprise hardware, software, firmware, or any combination thereof (other than software per se). Computing device 804, as depicted in FIG. 6, is merely one example, and claimed subject matter is not limited in scope to this particular example.

For one or more embodiments, a device, such as a computing device and/or networking device, may comprise, for example, any of a wide range of digital electronic devices, including, but not limited to, desktop and/or notebook computers, high-definition televisions, digital versatile disc (DVD) and/or other optical disc players and/or recorders, game consoles, satellite television receivers, cellular telephones, tablet devices, wearable devices, personal digital assistants, mobile audio and/or video playback and/or recording devices, Internet of Things (IoT) type devices, or any combination of the foregoing. Further, unless specifically stated otherwise, a process as described, such as with reference to flow diagrams and/or otherwise, may also be executed and/or affected, in whole or in part, by a computing device and/or a network device. A device, such as a computing device and/or network device, may vary in terms of capabilities and/or features. Claimed subject matter is intended to cover a wide range of potential variations. For example, a device may include a numeric keypad and/or other display of limited functionality, such as a monochrome liquid crystal display (LCD) for displaying text, for example. In contrast, however, as another example, a web-enabled device may include a physical and/or a virtual keyboard, mass storage, one or more accelerometers, one or more gyroscopes, global positioning system (GPS) and/or other location-identifying type capability, and/or a display with a higher degree of functionality, such as a touch-sensitive color 2D or 3D display, for example.

As suggested previously, communications between a computing device and/or a network device and a wireless network may be in accordance with known and/or to be developed network protocols including, for example, global system for mobile communications (GSM), enhanced data rate for GSM evolution (EDGE), 802.11 b/g/n/h, etc., and/or worldwide interoperability for microwave access (WiMAX). A computing device and/or a networking device may also have a subscriber identity module (SIM) card, which, for example, may comprise a detachable or embedded smart card that is able to store subscription content of a user, and/or is also able to store a contact list. It is noted, however, that a SIM card may also be electronic, meaning that is may simply be stored in a particular location in memory of the computing and/or networking device. A user may own the computing device and/or network device or may otherwise be a user, such as a primary user, for example. A device may be assigned an address by a wireless network operator, a wired network operator, and/or an Internet Service Provider (ISP). For example, an address may comprise a domestic or international telephone number, an Internet Protocol (IP) address, and/or one or more other identifiers. In other embodiments, a computing and/or communications network may be embodied as a wired network, wireless network, or any combinations thereof.

A computing and/or network device may include and/or may execute a variety of now known and/or to be developed operating systems, derivatives and/or versions thereof, including computer operating systems, such as Windows, iOS, Linux, a mobile operating system, such as iOS, Android, Windows Mobile, and/or the like. A computing device and/or network device may include and/or may execute a variety of possible applications, such as a client software application enabling communication with other devices. A computing and/or network device may also include executable computer instructions to process and/or communicate digital content. A computing and/or network device may also include executable computer instructions to perform a variety of possible tasks, such as browsing, searching, playing various forms of digital content, including locally stored and/or streamed video, and/or games such as, but not limited to, fantasy sports leagues. A computing and/or network device may also process input content as a prompt to one or more generative neural network models to provide output content. A computing and/or network device may also perform linguistic processing such as applying transforms to determine an embedding of tokens and/or apply attention models to determine service codes. The foregoing is provided merely to illustrate that claimed subject matter is intended to include a wide range of possible features and/or capabilities.

In FIG. 6, computing device 802 may provide one or more sources of executable computer instructions in the form physical states and/or signals (e.g., stored in memory states), for example. Computing device 802 may communicate with computing device 804 by way of a network connection, such as via network 808, for example. As previously mentioned, a connection, while physical, may not necessarily be tangible. Although computing device 804 of FIG. 6 shows various tangible, physical components, claimed subject matter is not limited to a computing devices having only these tangible components as other implementations and/or embodiments may include alternative arrangements that may comprise additional tangible components or fewer tangible components, for example, that function differently while achieving similar results. Rather, examples are provided merely as illustrations. It is not intended that claimed subject matter be limited in scope to illustrative examples.

Memory 822 may comprise any non-transitory storage mechanism. Memory 822 may comprise, for example, primary memory 824 and secondary memory 826, additional memory circuits, mechanisms, or combinations thereof may be used. Memory 822 may comprise, for example, random access memory, read only memory, etc., such as in the form of one or more storage devices and/or systems, such as, for example, a disk drive including an optical disc drive, a tape drive, a solid-state memory drive, etc., just to name a few examples.

Memory 822 may be utilized to store a program of executable computer instructions. For example, processor 820 may fetch executable instructions from memory and proceed to interpret and execute the fetched instructions. Memory 822 may also comprise a memory controller for accessing device readable-medium 840 that may carry and/or make accessible digital content, which may include code, and/or instructions, for example, executable by processor 820 and/or some other device, such as a controller, as one example, capable of executing computer instructions, for example. Under direction of processor 820, a non-transitory memory, such as memory cells storing physical states (e.g., memory states), comprising, for example, a program of executable computer instructions, may be executed by processor 820 and able to generate signals to be communicated via a network, for example, as previously described. Generated signals may also be stored in memory, also previously suggested. In a particular implementation, processor 820 may include general processing cores and/or specialized co-processing cores (e.g., signal processors, graphical processing unit (GPU) and/or neural network processing unit (NPU)), for example.

Memory 822 may store electronic files and/or electronic documents, such as relating to one or more users, and may also comprise a computer-readable medium that may carry and/or make accessible content, including code and/or instructions, for example, executable by processor 820 and/or some other device, such as a controller, as one example, capable of executing computer instructions, for example. As previously mentioned, the term electronic file and/or the term electronic document are used throughout this document to refer to a set of stored memory states and/or a set of physical signals associated in a manner so as to thereby form an electronic file and/or an electronic document. That is, it is not meant to implicitly reference a particular syntax, format and/or approach used, for example, with respect to a set of associated memory states and/or a set of associated physical signals. It is further noted an association of memory states, for example, may be in a logical sense and not necessarily in a tangible, physical sense. Thus, although signal and/or state components of an electronic file and/or electronic document, are to be associated logically, storage thereof, for example, may reside in one or more different places in a tangible, physical memory, in an embodiment.

Algorithmic descriptions and/or symbolic representations are examples of techniques used by those of ordinary skill in the signal processing and/or related arts to convey the substance of their work to others skilled in the art. An algorithm is, in the context of the present patent application, and generally, is considered to be a self-consistent sequence of operations and/or similar signal processing leading to a desired result. In the context of the present patent application, operations and/or processing involve physical manipulation of physical quantities. Typically, although not necessarily, such quantities may take the form of electrical and/or magnetic signals and/or states capable of being stored, transferred, combined, compared, processed and/or otherwise manipulated, for example, as electronic signals and/or states making up components of various forms of digital content, such as signal measurements, text, images, video, audio, etc.

It has proven convenient at times, principally for reasons of common usage, to refer to such physical signals and/or physical states as bits, service codes, tokens, computed likelihoods, values, elements, parameters, symbols, characters, terms, numbers, numerals, measurements, content and/or the like. It should be understood, however, that all of these and/or similar terms are to be associated with appropriate physical quantities and are merely convenient labels. Unless specifically stated otherwise, as apparent from the preceding discussion, it is appreciated that throughout this specification discussions utilizing terms such as “processing,” “computing,” “calculating,” “determining”, “establishing”, “obtaining”, “identifying”, “selecting”, “generating”, and/or the like may refer to actions and/or processes of a specific apparatus, such as a special purpose computer and/or a similar special purpose computing and/or network device. In the context of this specification, therefore, a special purpose computer and/or a similar special purpose computing and/or network device is capable of processing, manipulating and/or transforming signals and/or states, typically in the form of physical electronic and/or magnetic quantities, within memories, registers, and/or other storage devices, processing devices, and/or display devices of the special purpose computer and/or similar special purpose computing and/or network device. In the context of this particular patent application, as mentioned, the term “specific apparatus” therefore includes a general purpose computing and/or network device, such as a general purpose computer, once it is programmed to perform particular functions, such as pursuant to program software instructions.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and/or storage of charge or a release of stored charge. Likewise, in other memory devices, a change of state may comprise a physical change, such as a transformation in magnetic orientation. Likewise, a physical change may comprise a transformation in molecular structure, such as from crystalline form to amorphous form or vice-versa. In still other memory devices, a change in physical state may involve quantum mechanical phenomena, such as, superposition, entanglement, and/or the like, which may involve quantum bits (qubits), for example. The foregoing is not intended to be an exhaustive list of all examples in which a change in state from a binary one to a binary zero or vice-versa in a memory device may comprise a transformation, such as a physical, but non-transitory, transformation. Rather, the foregoing is intended as illustrative examples.

Referring again to FIG. 6, processor 820 may comprise one or more circuits, such as digital circuits, to perform at least a portion of a computing procedure and/or process. By way of example, but not limitation, processor 820 may comprise one or more processors, such as controllers, microprocessors, microcontrollers, application specific integrated circuits, GPUs, NPUs, digital signal processors, programmable logic devices, field programmable gate arrays, the like, or any combination thereof. In various implementations and/or embodiments, processor 820 may perform signal processing, typically substantially in accordance with fetched executable computer instructions, such as to manipulate signals and/or states, to construct signals and/or states, etc., with signals and/or states generated in such a manner to be communicated and/or stored in memory, for example.

FIG. 6 also illustrates device 804 as including a component 832 operable with input/output devices, for example, so that signals and/or states may be appropriately communicated between devices, such as device 804 and an input device and/or device 804 and an output device. A user may make use of an input device, such as a computer mouse, stylus, track ball, microphone, scanner, keyboard, and/or any other similar device capable of receiving user actions and/or motions as input signals. Likewise, for a device having speech to text capability, a user may speak to a device to generate input signals. A user may make use of an output device, such as a display, a printer, etc., and/or any other device capable of providing signals and/or generating stimuli for a user, such as visual stimuli, audio stimuli and/or other similar stimuli.

In this context, a “neural network” as referred to herein means an architecture of a processing device defined and/or represented by a graph including nodes to represent neurons that process input signals to generate output signals, and edges connecting the nodes to represent input and/or output signal paths between and/or among neurons represented by the graph. In particular implementations, a neural network may comprise a biological neural network, made up of real biological neurons, or an artificial neural network, made up of artificial neurons, for solving artificial intelligence (AI) problems, for example. In an implementation, such an artificial neural network may be implemented by one or more computing devices such as computing devices including a central processing unit (CPU), graphics processing unit (GPU), digital signal processing (DSP) unit and/or neural processing unit (NPU), just to provide a few examples. In a particular implementation, neural network weights and/or numerical coefficients associated with edges to represent input and/or output paths may reflect gains to be applied and/or whether an associated connection between connected nodes is to be excitatory (e.g., weight with a positive value) or inhibitory connections (e.g., weight with negative value). In an example implementation, a neuron may apply a neural network weight to input signals, and sum weighted input signals to generate a linear combination.

According to an embodiment, edges in a neural network connecting nodes may model synapses capable of transmitting signals (e.g., represented by real number values) between neurons. Responsive to receipt of such a signal, a node/neural may perform some computation to generate an output signal (e.g., to be provided to another node in the neural network connected by an edge). Such an output signal may be based, at least in part, on one or more weights and/or numerical coefficients associated with the node and/or edges providing the output signal. For example, such a weight may increase or decrease a strength of an output signal. In a particular implementation, such weights and/or numerical coefficients may be adjusted and/or updated as a machine learning process progresses. In an implementation, transmission of an output signal from a node in a neural network may be inhibited if a strength of the output signal does not exceed a threshold value.

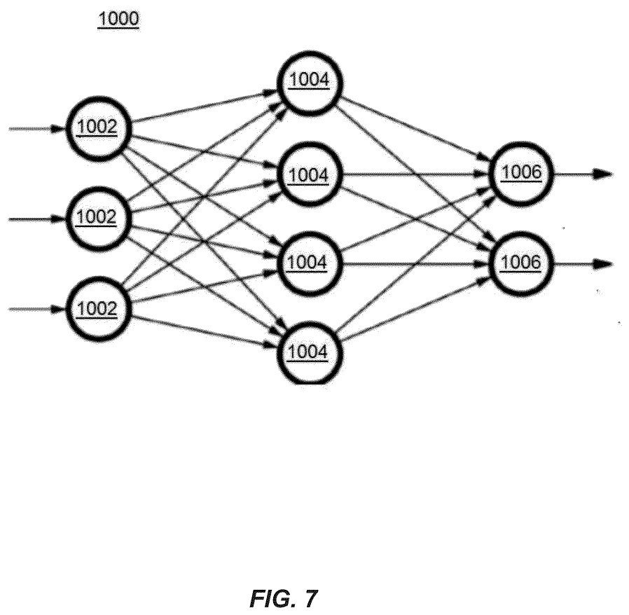

FIG. 7 is a schematic diagram of a neural network 1000 formed in “layers” in which an initial layer is formed by nodes 1002 and a final layer is formed by nodes 1006. All or a portion of features of NN 1000 may be implemented in aspects of neural networks making up generative neural network models 210, 310 and/or 600, for example. Neural network (NN) 1000 may include an intermediate layer formed by nodes 1004. Edges shown between nodes 1002 and 1004 illustrate signal flow from an initial layer to an intermediate layer. Likewise, edges shown between nodes 1004 and 1006 illustrate signal flow from an intermediate layer to a final layer. While neural network 1000 shows a single intermediate layer formed by nodes 1004, it should be understood that other implementations of a neural network may include multiple intermediate layers formed between an initial layer and a final layer.

According to an embodiment, a node 1002, 1004 and/or 1006 may process input signals (e.g., received on one or more incoming edges) to provide output signals (e.g., on one or more outgoing edges) according to an activation function. An “activation function” as referred to herein means a set of one or more operations associated with a node of a neural network to map one or more input signals to one or more output signals. In a particular implementation, such an activation function may be defined based, at least in part, on a weight associated with a node of a neural network. Operations of an activation function to map one or more input signals to one or more output signals may comprise, for example, identity, binary step, logistic (e.g., sigmoid and/or soft step), hyperbolic tangent, rectified linear unit, Gaussian error linear unit, Softplus, exponential linear unit, scaled exponential linear unit, leaky rectified linear unit, parametric rectified linear unit, sigmoid linear unit, Swish, Mish, Gaussian and/or growing cosine unit operations. It should be understood, however, that these are merely examples of operations that may be applied to map input signals of a node to output signals in an activation function, and claimed subject matter is not limited in this respect. Additionally, an “activation input value” as referred to herein means a value provided as an input parameter and/or signal to an activation function defined and/or represented by a node in a neural network. Likewise, an “activation output value” as referred to herein means an output value and/or signal provided by an activation function defined and/or represented by a node of a neural network. In a particular implementation, an activation output value may be computed and/or generated according to an activation function based on and/or responsive to one or more activation input values received at a node. In a particular implementation, an activation input value and/or activation output value may be structured, dimensioned and/or formatted as “tensors”. Thus, in this context, an “activation input tensor” or “input tensor” as referred to herein means an expression of one or more activation input values according to a particular structure, dimension and/or format. Likewise in this context, an “activation output tensor” or “output tensor” as referred to herein means an expression of one or more activation output values according to a particular structure, dimension and/or format.

According to an embodiment, neural network 1000 may be characterized as having a particular structure or topology based on, for example, a number of layers, number of nodes in each layers, activation functions implemented at each node, quantization of weights and quantization of input/output activations. Neural network 1000 may be further characterized by weights to be assigned to nodes to affect activation functions at respective nodes. During execution, neural network 1000 may be characterized as having a particular state or “intermediate state” determined based on values/signals computed by nodes (e.g., as activation values to be provided to nodes in a subsequent layer of nodes and/or an output tensor).

In particular implementations, neural networks may enable improved results in a wide range of tasks, including image recognition, speech recognition, content generation, just to provide a couple of example applications. To enable performing such tasks, features of a neural network (e.g., nodes, edges, weights, layers of nodes and edges) may be structured and/or configured to form “filters” that may have a measurable/numerical state such as a value of an output signal. Such a filter may comprise nodes and/or edges arranged in “paths” and are to be responsive to sensor observations provided as input signals. In an implementation, a state and/or output signal of such a filter may indicate and/or infer detection of a presence or absence of a feature in an input signal.

In particular implementations, intelligent computing devices to perform functions supported by neural networks may comprise a wide variety of stationary and/or mobile devices, such as, for example, automobile sensors, biochip transponders, heart monitoring implants, Internet of things (IoT) devices, kitchen appliances, locks or like fastening devices, solar panel arrays, home gateways, smart gauges, robots, financial trading platforms, smart telephones, cellular telephones, security cameras, wearable devices, thermostats, Global Positioning System (GPS) transceivers, personal digital assistants (PDAs), virtual assistants, laptop computers, personal entertainment systems, tablet personal computers (PCs), PCs, personal audio or video devices, personal navigation devices, just to provide a few examples.

According to an embodiment, a neural network may be structured in layers such that a node in a particular neural network layer may receive output signals from one or more nodes in an upstream layer in the neural network, and provide an output signal to one or more nodes in a downstream layer in the neural network. One specific class of layered neural networks may comprise a convolutional neural network (CNN) or space invariant artificial neural networks (SIANN) that enable deep learning. Such CNNs and/or SIANNs may be based, at least in part, on a shared-weight architecture of a convolution kernels that shift over input features and provide translation equivariant responses. Such CNNs and/or SIANNs may be applied to image and/or video recognition, recommender systems, image classification, image segmentation, medical image analysis, natural language processing (e.g., medical records processing), brain-computer interfaces, financial time series, just to provide a few examples.

Another class of layered neural network may comprise a recursive neural network (RNN) that is a class of neural networks in which connections between nodes form a directed cyclic graph along a temporal sequence. Such a temporal sequence may enable modeling of temporal dynamic behavior. In an implementation, an RNN may employ an internal state (e.g., memory) to process variable length sequences of inputs. This may be applied, for example, to tasks such as unsegmented, connected handwriting recognition or speech recognition, just to provide a few examples. In particular implementations, an RNN may emulate temporal behavior using finite impulse response (FIR) or infinite impulse response (IIR) structures. An RNN may include additional structures to control stored states of such FIR and IIR structures to be aged. Structures to control such stored states may include a network or graph that incorporates time delays and/or has feedback loops, such as in long short-term memory networks (LSTMs) and gated recurrent units.

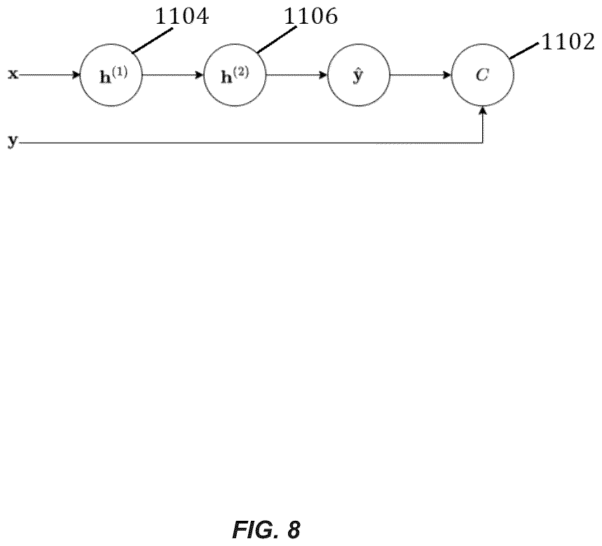

According to an embodiment, output signals of one or more neural networks (e.g., taken individually or in combination) may at least in part, define a “predictor” to generate prediction values associated with some observable and/or measurable phenomenon and/or state. In an implementation, a neural network may be “trained” to provide a predictor that is capable of generating such prediction values based on input values (e.g., measurements and/or observations) optimized according to a loss function. For example, a training process may employ backpropagation techniques. “Backpropagation,” as referred to herein, is to mean a process of fitting parameters of a trained inference model such a model comprising one or more neural networks. In fitting parameters of a neural network, for example, backpropagation is to compute a gradient of a loss function with respect to the weights of the neural network. Based on such a computed gradient of a loss function, weights may be updated so as to minimize and/or reduce such a loss function. In one particular implementation, a gradient descent of a loss function, or variants such as stochastic gradient descent of a loss function, may be used. In training parameters of a neural network, backpropagation may comprise computing a gradient of a loss function with respect to individual weights by the chain rule, computing a gradient one layer at a time, iterating backward from the last layer to avoid redundant calculations of intermediate terms in the chain rule, for example. It should be understood, however, that this is merely an example of how a process of backpropagation may be applied, and claimed subject matter is not limited in this respect. In particular implementations, backpropagation may be used to iteratively update neural network weights to be associated with nodes and/or edges of a neural network based, at least in part on “training sets.” Such training sets may include training measurements and/or observations to be supplied as input values that are paired with “ground truth” observations. Based on a comparison of such ground truth observations and associated prediction values generated based on such input values in a training process, weights may be updated according to a loss function using backpropagation. FIG. 8 is a flow diagram of an aspect of a training operation employing backpropagation to train parameters for a feedforward neural network, according to an embodiment. It should be understood, however, that this is merely an example of a type of neural network that may be trained using backpropagation, and that similar backpropagation techniques may be applied to train parameters of other types of neural networks without deviating from claimed subject matter. Training sets may be provided to such a training operation as pairs of vectors (x,y) where x is an input vector and y is a corresponding ground truth label. Input vector x may be provided as an input tensor to a first hidden layer 1104 to produce an output vector h\hat{ }((1)), which is provided as an input to a second hidden layer 1106 to provide an output vector h\hat{ }((2)). An inference and/or prediction y\hat{ } may be computed based, at least in part, on the output vector h\hat{ }((2)). A loss value C may be computed at 1102 according to one or more loss functions based, at least in part, on inference and/or prediction y\hat{ } and ground truth label y.

In the particular embodiment of FIG. 8, inference and/or prediction y\hat{ }, and output vectors h\hat{ }((1)) and h\hat{ }((2)) may be modelled as follows:

$$h \hat{} ( ( 1 ) ) = g \hat{} ( ( 1 ) ) ( W \hat{} ( 1 ) Tx + b \hat{} ( ( 1 ) ) )$$

$$h \hat{} ( ( 2 ) ) = g \hat{} ( ( 2 ) ) ( W \hat{} ( 2 ) Th \hat{} ( ( 1 ) ) + b \hat{} ( ( 2 ) ) )$$

$$y \hat{} ( x ) = W \hat{} ( 3 ) Th \hat{} ( ( 2 ) ) + b \hat{} ( ( 3 ) ) ,$$

where:
g\hat{ }((i)) is an activation function applied at nodes in hidden layer i;
W\hat{ }((i)) is a matrix of weights such that weight W_jk\hat{ }((i)) is to be applied at an edge going from node j in layer i−1 to node k in hidden layer i; and
b\hat{ }((i)) is a bias matrix applied at hidden layer i.

In a particular implementation in which a feedforward neural network includes three or more hidden layers, computation of y\hat{ }(x) may be generalized as follows:

$$y \hat{} ( x ) = W \hat{} ( N ) Th \hat{} ( ( N - 1 ) ) + b \hat{} ( ( N ) ) .$$

Loss value C(y,y\hat{ }) may be computed according to any one of several formulations of a loss function include, for example, a means square error loss or mean absolute error loss, just provide a couple of examples of a loss function. In a particular implementation, a loss function to compute C(y,y\hat{ }) may be differentiable such that ∂C/(∂W_jk\hat{ }((i))) may be determined using the chain rule and may be computed for any weight W_jk\hat{ }((i)). According to an embodiment, values for W\hat{ }((i)) may be determined iteratively for training sets (x,y) using a gradient descent technique.

In this context, a “supervised operation” as referred to herein is to mean a machine-learning operation in which training sets provided as inputs for training iterations are paired with “ground truth” labels. In a training iteration/epoch of such a supervised operation, for example, a loss value may be computed based, at least in part, on an inference computed by a trainable model based on one or more input values a training set and a ground truth label in the training set paired with the one or more input values. For example, a supervised operation may execute a loss function to compute a loss value based, at least in part, on a comparison of a computed inference and ground truth observations/values paired with the computed inference. In this context, a “self-supervised operation” as referred to herein is to mean a machine-learning operation in which input training sets are provided without “ground truth” labels. In a training iteration/epoch of such a self-supervised operation, for example, a loss function may compute a loss value based, at least in part, on an inference computed based on a training set and in the absence of any ground truth label paired with the training set.

In the preceding description, various aspects of claimed subject matter have been described. For purposes of explanation, specifics, such as amounts, systems and/or configurations, as examples, were set forth. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all modifications and/or changes as fall within claimed subject matter.

What is claimed is:

1. A method, comprising:
receiving one or more first content messages, the one or more first content messages comprising a first prompt specifying a requested response to be computed;
responsive to the first prompt, submitting a second prompt to one or more generative neural network models based, at least in part, on the first prompt, the second prompt specifying a plurality of computing tools for use in constructing the requested response, the second prompt requesting an identification of tasks to be executed based, at least in part, on at least some of the plurality of computing tools and based, at least in part, on execution dependencies between and/or among the identified tasks;
receiving from the one or more generative neural network models, one or more second content messages specifying the identified tasks and an order of execution of the identified tasks based, at least in part, on the execution dependencies between and/or among the identified tasks; and
initiating execution of identified tasks according to the order of execution to generate the requested response.

2. The method of claim 1, wherein the one or more first content messages are initiated by a graphical user interface (GUI).

3. The method of claim 1, wherein:
the first prompt and/or second prompt makes reference to one or more previous interactions of a user with at least one of the one or more generative neural network models; and
the identified tasks and/or the order of execution of the identified tasks are further based, at least in part, on the one or more previous interactions of the user with the at least one of the one or more generative neural network models.

4. The method of claim 1, wherein at least one of the execution dependencies between and/or among the identified tasks reflects that at least a first task of the identified tasks is to complete execution prior to commencement of at least a second task of the identified tasks.

5. The method of claim 4, wherein an execution result of the first task affects an execution result of the second task.

6. The method of claim 1, wherein:
the requested response comprises computer code to provide a computation result; and
the identified tasks comprise computer code modules.

7. The method of claim 1, wherein the first prompt further comprises natural language descriptions of the computing tools.

8. The method of claim 7, wherein the natural language descriptions of the computing tools comprise indications of input values and/or output values for respective computing tools in a library of computer code modules.

9. The method of claim 6, wherein the computer code modules are identified based, at least in part, on an execution history of at least some of a plurality of computer code modules in a library of computer code modules.

10. The method of claim 1, wherein:
the first prompt is formulated by a user; and
the first prompt further comprises a history of previous interactions of the user with a graphical user interface (GUI).

11. The method of claim 10, wherein the history of previous interactions of the user with the GUI further comprises previous prompts submitted to the GUI and corresponding responses to the previous prompts.

12. The method of claim 1, wherein:
computing tools comprise one or more modules of computer-readable instructions; and
the requested response comprises computer code integrating at least one of the one or more modules.

13. The method of claim 1, wherein: the one or more second content messages comprise instructions formatted according to a JavaScript Object Notation (JSON).

14. The method of claim 1, wherein execution of at least one of the identified tasks comprises:
submitting a third prompt to at least one of the one or more generative neural network models, the third prompt specifying a plurality of computing tools for use in executing the at least one of the identified tasks, the third prompt requesting an identification of subtasks to be executed based, at least in part, on at least some of the plurality of computing tools for use in executing the at least one of the identified tasks and based, at least in part, on execution dependencies between and/or among the identified subtasks; and
receiving from the at least one of the one or more generative neural network models, one or more third messages specifying the identified subtasks and an order of execution of the identified subtasks based, at least in part, on the execution dependencies between and/or among the identified subtasks.

15. The method of claim 14, wherein:
the first prompt and/or third prompt specify one or more previous interactions of a user with at least one of the one or more generative neural network models; and
the identified subtasks and/or the order of execution of the identified subtasks are further based, at least in part, on the specified one or more previous interactions of the user with the at least one of the one or more generative neural network models.

16. An apparatus comprising:
one or more memory devices; and
one or more processors coupled to the memory device, the one or more processors to:
obtain a first prompt specifying a requested response to be computed;
responsive to the first prompt, submit a second prompt to one or more generative neural network models based, at least in part, on the first prompt, the second prompt specifying a plurality of computing tools for use for construction of the requested response, the second prompt to request an identification of tasks to be executed based, at least in part, on at least some of the plurality of computing tools and based, at least in part, on execution dependencies between and/or among the identified tasks;
obtain, from one or more messages received from the one or more generative neural network models, one or more messages specifying the identified tasks and an order of execution of the identified tasks based, at least in part, on the dependencies between and/or among the identified tasks; and
initiate execution of identified tasks according to the order of execution to generate the requested response.

17. The apparatus of claim 16, wherein:
the first prompt and/or second prompt makes reference to one or more previous interactions of a user with the at least one of the one or more generative neural network models; and
the identified tasks and/or the order of execution of the identified tasks are further based, at least in part, on the one or more previous interactions of the user with the at least one of the one or more generative neural network models.

18. The apparatus of claim 16, wherein execution of at least one of the identified tasks comprises:
submission of a third prompt to at least one of the one or more generative neural network models, the third prompt specifying a plurality of computing tools for use in executing the at least one of the identified tasks, the third prompt requesting an identification of subtasks to be executed based, at least in part, on at least some of the plurality of computing tools for use in executing the at least one of the identified tasks and based, at least in part, on execution dependencies between and/or among the identified subtasks; and
obtaining from one or more third messages received from the one or more generative neural network models, specification of the identified subtasks and an order of execution of the identified subtasks based, at least in part, on the execution dependencies between and/or among the identified subtasks.

19. The apparatus of claim 18, wherein:
the first prompt and/or third prompt specify one or more previous interactions of a user with the at least one of the generative neural network models; and
the identified subtasks and/or the order of execution of the identified subtasks are further based, at least in part, on the specified one or more previous interactions of the user with the at least one of the one or more generative neural network models.

20. An article, comprising:
a storage device having computer-readable instructions stored thereon that are executable by one or more processors of a computing device to:
obtain a first prompt specifying a requested response to be computed;
responsive to the first prompt, submit a second prompt to one or more generative neural network models based, at least in part, on the first prompt, the second prompt specifying a plurality of computing tools for use for construction of the requested response, the second prompt to request an identification of tasks to be executed based, at least in part, on at least some of the plurality of computing tools and based, at least in part, on execution dependencies between and/or among the identified tasks;
obtain, from one or more messages received from the one or more generative neural network models, one or more messages specifying the identified tasks and an order of execution of the identified tasks based, at least in part, on the execution dependencies between and/or among the identified tasks; and
initiate execution of identified tasks according to the order of execution to generate the requested response.
